(19) United States
(12) Patent Application Publication
(10) Pub. No.: US 2007/0005788 A1
(43) Pub. Date: Jan. 4, 2007

(54) Multicast streaming service method and system thereof

(76) Inventors: Chang-Hyun Kim, Gyeonggi-Do (KR); Hyo-Jun Im, Seoul (KR)

Correspondence Address: Jonathan Y. Kang;Lee, Hong, Degerman, Kang & Schmadeka, 801 S. Figueroa St., 14th Floor, Los Angeles, CA, 90017, US

(21) Appl. No.: 10/573,396

(22) PCT Filed: Sep. 21, 2004
(86) PCT No.: PCT/KR04/02422

§ 371 Date: Mar. 22, 2006

(30) Foreign Application Priority Data
Sep. 22, 2003 (KR) 10-2003-0065676

(51) Int. Cl. G06F 15/16

(52) U.S. Cl. 709/231

(57) ABSTRACT

A multicast streaming service method and system thereof allow effective control for multicast streaming in UPnP by defining actions such as MulticastStart( ), Join( ), Leave( ) and the like to allow a multicast service under a UPnP AV standard. The multicast streaming service method and system comprise checking contents by a control point and instructing a media server to start multicast streaming by the control point; informing, by the media server, a multicast group address to the control point for receiving the corresponding contents; informing, by the control point, the multicast group address to a plurality of media renderers; and receiving, by the media renderers, the corresponding contents upon joining by using the multicast group address and checking the multicast group address.

### TECHNICAL FIELD

The present invention relates to a home networking service, and more particularly to, a multicast streaming service and system in the UPnP™ technology.

### BACKGROUND ART

Recently, with the distribution of very high speed internet and the digitalization of home electric appliances, there is being made an attempt to configure PCs (personal computers), network gateway apparatuses, audio/video devices, home electronic equipment, control devices, etc. at home as a single home network.

Currently, as a PC-based network environment has been changing more and more into an environment employing a variety of subnetwork techniques with the spread of home networking, there has been suggested Universal Plug and Play (UPnP) technology with the need for a technique capable of networking home electric appliances in an independent and unified way using an IP protocol.

The aforementioned UPnP is defined by the protocol of a standard network architecture, which is one of the leading standard techniques for home networks being made by establishing a UPnP forum between a number of companies of in countries around the world. The above UPnP-based home network system is comprised of multiple UPnP devices providing services and a control point (CP) controlling the multiple UPnP devices.

The control point (CP) denotes a controller having the function of sensing and controlling a variety of devices. That is, the control point (CP), as the controller controlling a variety of devices (for example, UPnP devices), discovers various kinds of UPnP devices, finds out the descriptions of the discovered UPnP devices and controls the UPnP devices according to a user's key input.

The UPnP devices include PCs (personal computers), network equipment, peripheral devices, such as a printer, audio/video devices, home electric equipment, etc. which are all connected to a home network. They inform the control point of their event.

The current UPnP-based home network system controlling audio/video devices comprises: a media server MS providing media contents via a home network; a media renderer MR playing media contents provided via the home network; and a control point CP controlling the media server MS and the media renderer MR.

The control point CP is informed of the status information of the media server MS and of the media renderer MR through an event. For instance, when the media server MS and the media renderer MR provide AV (audio/video) transport service and rendering control service, a changed state variable is put into a state variable table named ‘Last Change’ and the control point CP is informed of the changed state variable, to thus enable the control point CP to know the current state of a device.

The media server MS informs the control point CP of the information on the media contents whenever an UPnP action occurs. Further, the media server MS transmits the corresponding media contents to the media renderer MR by a streaming method in order to play the media contents.

The media renderer MR plays the transmitted media contents. At this time, although the above streaming method can be any of various methods suggested, the current UPnP Audio/Video V standard uses ‘Out-of-Band transfer protocol’ for streaming.

For example, RTSP (real-time streaming protocol)-RTP (real time transport protocol) may be used for transmitting contents. In case of a program using RTSP-RTP, contents are sent using RTP over UDP (User Datagram Protocol). At this time, in order to view the contents sent from the media server MS, each client has to join a RTSP session and then leave. To manage this, a RTSP server is operated.

Therefore, a RTSP-RTP player is able to join the RTSP session by using an address informed by the RTSP server, and once the RTSP-RTP player join the RTSP session, it becomes capable of playing the contents being sent from the server using RTP.

In the conventional UPnP AV standards, however, the media renderer is operated based on the concept that one media renderer plays one content sent from the media server. But in case that the media server receives a TV signal and sends it to the media renderer, you might want to see the same channel on a number of displays simultaneously.

Moreover, let us suppose that a monitoring camera exists in a house and images taken by the camera are stored in a server at real time. In this case, a member of the house might want to look at something happening in front of the house at the same time.

Besides, in case where the person having watched the TV in the living room moves to another place, when TV contents are sent by multicasting, another media renderer in the another place joins the multicast group, thereby making him or her not to miss but watch the program he or she watched a little while ago.

To realize the aforementioned scenarios, the UPnP AV device must be able to send contents to the multicast group, and to joint and leave the multicast group.

However, in the conventional UPnP AV standards, only the circumstances of establishing a connection between the media server and the media renderer and transmitting media data are taken into consideration, thus in case of sending and receiving contents to/from a multicast group, this cannot be controlled effectively. That is, in the conventional UPnP AV standards, a multicast model is not taken into consideration, thus this makes it difficult to realize a multicast streaming service.

### DISCLOSURE OF THE INVENTION

Therefore, an object of the present invention is to provide a multicast streaming service method and system which are devised to enable an efficient control of multicast streaming on an UPnP by defining actions such as MulticastSTart( ), Join( ) and Leave( ) in order to enable a multicast service by UPnP AV standards.

To achieve the above object, there is provided a multicast streaming service method according to the present invention, in a UPnP AV network control method of performing a streaming transmission for playing media by having a media server MS, multiple media renderers MR and a control point CP controlling the media server and the renderers, comprising the steps in which: the control point confirms contents and invokes a multicast streaming start action to the media server, the media server informs the control point of a multicast group address for receiving the corresponding contents; the control point informs the multiple media renderers of the multicast group address; and the multiple media renderers join the multicast group address, confirm the multicast address and receive the corresponding contents.

Preferably, the multicast streaming service method comprises the step in which the media server starts the multicast streaming of the contents before and after the control point informs the multiple media renderes of the multicast group address.

To achieve the above object, there is provided a multicast streaming service method according to the present invention, in a UPnP AV network control method of performing a streaming transmission for playing media by having a media server MS, comprising the step of informing of a multicast group address if multicast start action is recognized and multicast streaming corresponding contents to the multicast address using a RTSP server.

To achieve the above object, there is provided a multicast streaming service method according to the present invention, in a UPnP AV network control method of performing media playing by having multiple media renderers MR, comprising the steps of: confirming if contents are multicast or not; receiving a multicast group address if the presence of multicasting is confirmed; and joining the multicast group address, confirming the multicast address and receiving the corresponding multicast contents.

To achieve the above object, there is provided a multicast streaming service system according to the present invention, comprising: a media server MS providing a multicast group address and multicasting corresponding contents to a multicast address using a RTSP server; multiple media renderers MR joining the RTSP server to confirm the multicast address and playing the contents transmitted to the multicast address; and a control point CP confirming the contents to is be multicast, invoking a multicast start action to the media server and informing the multiple media renderers of the multicast group address provided from the media server.

Preferably, the media server starts multicasting of the corresponding contents after transmission of the multicast group address to the control point or after a lapse of a predetermined time since the transmission of the multicast group address.

Preferably, the multicast group address is an address of the RTSP server.

Preferably, the multicast address is a fixed multicast address for contents multicasting or a mobile multicast address using the media server.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a signal flow chart showing a multicast service process according to an embodiment of the present invention;

FIGS. 2 and 3 are operating sequence charts showing a multicast transmission/reception process according to the embodiment of the present invention; and

FIGS. 4 to 7 are exemplified views showing additional actions for a multicast service according to the embodiment of the present invention.

### MODES FOR CARRYING OUT THE PREFERRED EMBODIMENTS

In a preferred embodiment of the present invention, UPnP actions required for transmitting/receiving multicast data on an UPnP will be defined and the procedure of performing multicast transmission and reception using these actions will be described.

In a multicast model of an IP according to the embodiment of the present invention, a media server MS transmits data to a specific multicast address, and a client wanting to receive the data, i.e., a media renderer MR, subscribes to the corresponding multicast address.

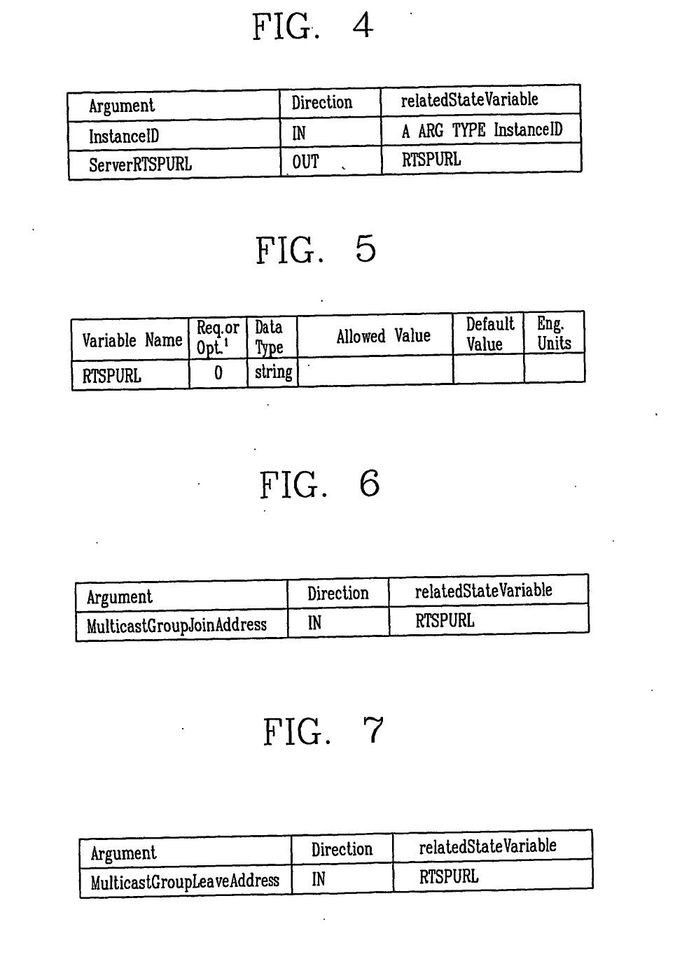

To adapt the multicast model to a UPnP, as shown in FIGS. 4 to 7, UPnP actions such as MulticastStart( ), Join( ) and Leave( ), are introduced.

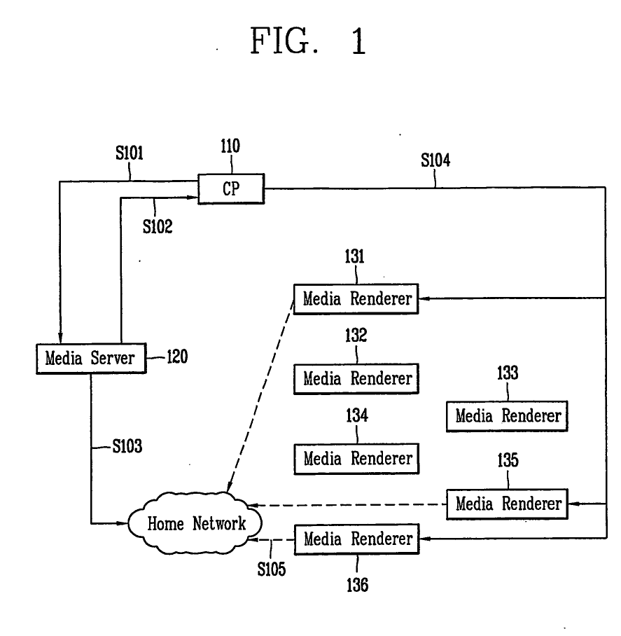

FIG. 1 is a signal flow chart according to an embodiment of the present invention.

As shown in FIG. 1, a multicast streaming service method comprises the steps in which: a control point 110 invokes ‘MulticastStart( )’ action to a media server 120 to request for the transmission of designated contents to a multicast address S101; the media server 120 delivers a RTSP URL (RTSP server address), which is to be accessed for receiving the corresponding contents, to the control point 110 in response to ‘MulticastStart( )’ action S102; the media server 120 transmits the corresponding contents to the multicast address using RTP S103; the control point 110 informs multiple media renderers 131 to 136 wanting to join a multicast group of the RTSP URL by using ‘Joint( )’ action S104; and one of the media renderers 131 to 136 wanting to joint the multicast group accesses to a RTSP server of the media server 120 using the RTSP URL, acquires the properties of media data being transmitted and the multicast address and then receives multicast data using the acquired information S105. Here, the RTSP URL can be represented in the form of rtsp://ipaddress/path.

Further, the aforementioned method comprises the step in which the control point 110 invokes ‘Leave( )’ action of the one of the media renderers 131 to 136 having joined the multicast group in order to stop the data reception of the corresponding media renderer.

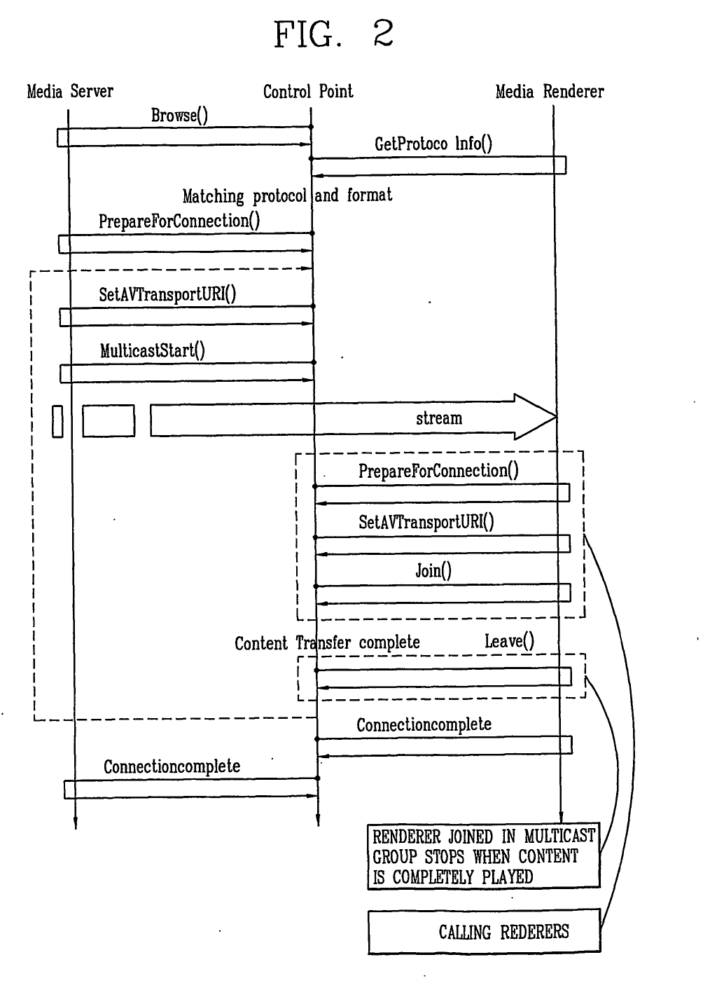

In the embodiment of the present invention thus configured, the process of playing contents in a media renderer using multicasting is the same as shown in the operating sequence chart of FIG. 2, which will be described as follows.

First, the control point 110 selects given contents through ‘Browse( )’ action and checks whether the media renderers 131 to 136 are able to play contents through ‘GetProtocolInfo( )’ action.

The control point 110 invokes ‘MulticastStart( )’ action if the media server 120 can provide the multicast function to push contents. At this time, upon the ‘MulticastStart( )’ action, as shown in FIGS. 4 and 5, the media server 120 provides ObjectID as an input parameter and RTSP URL used for joining the multicast group as an output parameter.

Afterwards, the media server 120 delivers the RTSP URL, which is to be accessed for receiving the corresponding contents, to the control point 110 in response to ‘MulticastStart( )’ action. The RTSP URL is in the form of rtsp://ipaddress/path.

Afterwards, the media server 120 starts contents transmission using RTP as a multicast address. At this time, the control point 110 informs a plurality of media renderers 131 to 136 wanting to play the contents of the RTSP URL provided from the media server 120 through ‘SetAVTransportURI’ action.

Accordingly, one of the media renderers 131 to 136 wanting to join the multicast group directly requests a RTSP server existing in the media server 120 to create a session.

Consequently, the media renderer having joined the multicast group allows a user to watch the corresponding contents by playing the contents being sent from the media server 120.

Afterwards, in order to leave the multicast group, the corresponding media renderer uses ‘Leave( )’ action received from the control point 110.

If the user wants to view the existing contents again after the contents are over, the user has to rejoin the multicast group after leaving the multicast group.

In such a general case, the play function can be used again once the contents are finished. In other words, in case the same contents are played again, depending on a vendor, the session of the media renderer that joined the multicast group before may be kept as it is.

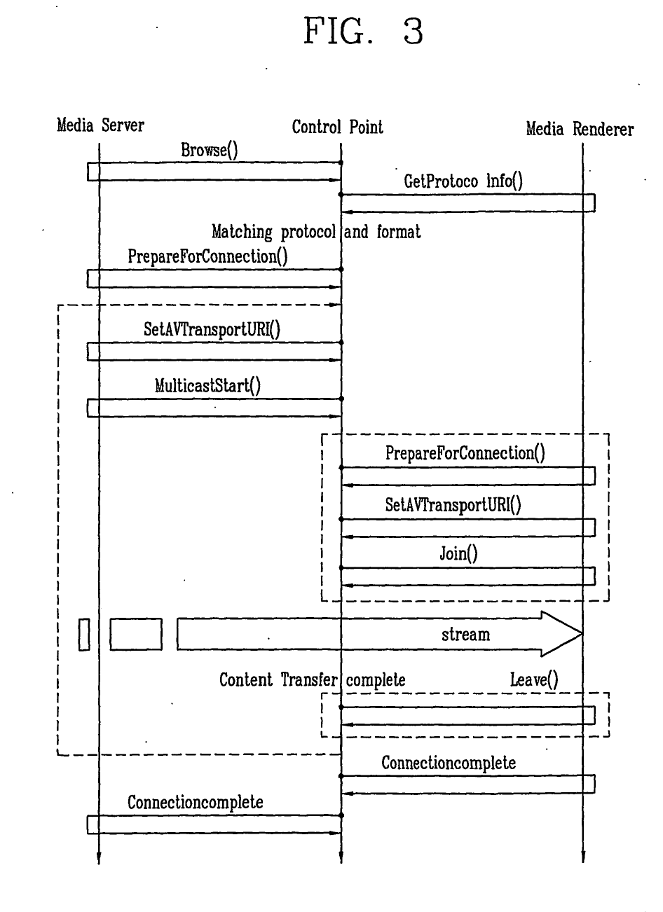

Meanwhile, in the embodiment of the present invention, the media renderer can be embodied so as to perform the process as shown in the operating sequence chart of FIG. 3, so that the multicast contents can meet the multicast time of the media server by delaying contents multicasting.

In case of transmitting and receiving multicast data by the process of FIG. 2 suggested in the embodiment of the present invention, since there exits a gap between the point of time when the media server 120 starts data transmission and the point of time when the one of the media renderers 131 to 136 having joined the multicast group starts data reception, the corresponding media renderer might not be able to play the first portion of the contents being currently transmitted.

Therefore, to solve the above problem, the media server 120 is configured to start streaming when the media renderer accesses via the RTSP server for the first time, rather than starting contents transmission as soon as it receives ‘MulticastStart( )’ action.

That is, in the operating process of FIG. 3 explained briefly in FIG. 1 as follows, the media server 120 is configured to perform the process in which the control point 110′ informs the media renderers 131 to 136 of the RTSP URL to be multicasted before starting the multicasting of contents.

Subsequently, the one of the media renderers 131 to 136 having joined the multicast group is able to play the first portion of the contents (for example, the first beginning portion of a specific movie) being transmitted from the media server 120 without missing it.

As described above in detail, the present invention provides the effect of reducing the load of a network since multiple renderers are able to simultaneously receive media data by one streaming connection by using multicasting so that the multiple media renderers MR can simultaneously watch the same contents provided from the media server MS.

1. A multicast streaming service method, in a UPnP AV network control method of performing a streaming transmission for playing media by having a media server MS, multiple media renderers MR and a control point CP controlling the media server and the renderers, comprising the steps in which:
the control point confirms contents and invokes a multicast streaming start action to the media server;
the media server informs the control point of a multicast group address for receiving the corresponding contents;
the control point informs the multiple media renderers of the multicast group address; and
the multiple media renderers join the multicast group address, confirm the multicast address and receive the corresponding contents.

2. The method of claim 1, comprising the step in which the media server starts the multicast streaming of the contents before the control point informs the multiple media renderes of the multicast group address.

3. The method of claim 1, comprising the step in which the media server starts the multicast streaming of the corresponding contents after a lapse of a predetermined time after informing the control point of the multicast group address so that the multiple media renderers can confirm the multicast group address and then receive the corresponding contents from the control point.

4. The method of claims 1, 2 and 3, wherein the multicast group address is a RTSP URL, the RTSP URL being in the form of rtsp://ipaddress/path.

5. The method of claim 1, comprising the step of finishing the reception of multicast contents if ‘Leave( )’ action invoking is recognized.

6. A multicast streaming service method, in a UPnP AV network control method of performing a streaming transmission for playing media by having a media server MS, comprising the step of informing of a multicast group address if multicast start action is recognized and multicast streaming corresponding contents to the multicast address using a RTSP server.

7. A multicast streaming service method, in a UPnP AV network control method of performing media playing by having multiple media renderers MR, comprising the steps of:
confirming if contents are multicast or not;
receiving a multicast group address if the presence of multicasting is confirmed; and
joining the multicast group address, confirming the multicast address and receiving the corresponding multicast contents.

8. A multicast streaming service system, comprising:
a media server MS providing a multicast group address and multicasting corresponding contents to a multicast address using a RTSP server;
multiple media renderers MR joining the RTSP server to confirm the multicast address and playing the contents transmitted to the multicast address; and
a control point CP confirming the contents to be multicast, invoking a multicast start action to the media server and informing the multiple media renderers of the multicast group address provided from the media server.

9. The system of claim 8, wherein the media server starts multicasting of the corresponding contents right after transmission of the multicast group address to the control point.

10. The system of claim 8, wherein the media server starts multicasting of the corresponding contents after a lapse of a predetermined time since the transmission of the multicast group address.

11. The method of claims 8, 9 and 10, wherein the multicast group address is a RTSP URL, the RTSP URL being in the form of rtsp://ipaddress/path.

12. A multicast streaming service method, in a UPnP AV network control method of performing a streaming transmission for playing media, comprising a media server informing of a multicast group address if multicast start action is recognized and multicast-streaming corresponding contents to the multicast address using a RTSP server.

13. A multicast streaming service method, in a UPnP AV network control method of performing a streaming transmission for playing media, comprising multiple media receiving a multicast group address if the presence of multicasting is confirmed, joining the multicast group address, confirming the multicast address and receiving the corresponding multicast contents.

14. The system of 14, wherein the multiple renderers finish the reception of multicast contents if ‘Leave( )’ action invoking is recognized.
